(19) United States
(12) Patent Application Publication
(10) Pub. No.: US 2026/0245777 A1
(43) Pub. Date: Aug. 20, 2026

(54) Low Magnetostriction Material For Read Sensors

(71) Applicant: Western Digital Technologies, Inc., San Jose, CA (US)

(72) Inventors: Chengju YU, San Jose, CA (US); James Mac FREITAG, Sunnyvale, CA (US); Susumu OKAMURA, San Jose, CA (US); Yuankai ZHENG, Fremont, CA (US); Zhitao DIAO, Fremont, CA (US)

(73) Assignee: Western Digital Technologies, Inc., San Jose, CA (US)

(21) Appl. No.: 19/056,508

(22) Filed: Feb. 18, 2025

(51) Int. Cl. H01F 10/32; G11B 5/31; H01F 1/153

(52) U.S. Cl. CPC H01F 10/3272; G11B 5/3146; H01F 1/153

(57) ABSTRACT

The present disclosure generally relates to magnetic recording devices comprising a read sensor. The sensor comprises a first buffer layer, a first ferromagnetic (FM) layer, the first FM layer comprising a single layer of Fe or FeSiAl, or a multilayer structure of Cr/Fe, NiAl/Fe, IrAl/Fe, FeSiAl/Fe, or Fe/FeSiAl, a first Co or CoFe interface layer, and a barrier layer. The sensor may further comprise a second Co or CoFe layer, and a second FM layer. The second FM layer may comprise a single layer of Fe or FeSiAl, or a multilayer structure of Fe/Cr, Fe/NiAl, Fe/IrAl, FeSiAl/Fe, or Fe/FeSiAl. The second FM layer may be amorphous. A synthetic anti-ferromagnetic (SAF) pinning and anti-ferromagnetic layer (AFM) may be disposed on the second FM layer. The sensor comprising one or more FM layers comprising Fe reduces the coercivity and magnetostriction and improves the stability of the read sensor.

### BACKGROUND OF THE DISCLOSURE

### Field of the Disclosure

Embodiments of the present disclosure generally relate to magnetic recording devices comprising a read head or read sensor.

### Description of the Related Art

The volume of data processed by a computer is increasing rapidly. To keep up with the volume of data processed, the storing and writing of data to a data storage device, such as a hard disk drive (HDD), must improve to adequately handle the volume of data. There is a need for higher recording density of a magnetic recording medium of the storage device to increase the function and the capability of a computer, and to continue processing the high volumes of data.

In order to achieve higher recording densities, such as recording densities exceeding 2 Tbit/in² for a magnetic recording medium, the width and pitch of data tracks are reduced, and thus the corresponding magnetically recorded bits encoded in each data track are narrowed. There have been many proposals which attempt to achieve small read back elements in both the down track and cross track directions.

As linear density increases, there is a natural tradeoff between resolution and signal-to-noise ratio (SNR), where either the SNR or the resolution suffers as the other increases. As track pitch decreases and the number of tracks-per-inch (tpi) increases, similar issues arise. Narrower devices which are required to read narrow tracks generally have inferior SNR and areal density capacity (ADC) to wider devices.

Therefore, there is a need in the art for an improved read head capable of reading data with an improved SNR and recording density.

### SUMMARY OF THE DISCLOSURE

The present disclosure generally relates to magnetic recording devices comprising a sensor. The sensor comprises a first buffer layer, a first ferromagnetic (FM) layer, the first buffer and FM layer comprising a single layer of Fe or FeSiAl, or a multilayer structure of Cr/Fe, NiAl/Fe, IrAl/Fe, FeSiAl/Fe, or Fe/FeSiAl, a first Co or CoFe layer, and a barrier layer. The sensor may further comprise a second Co or CoFe layer, a second interface layer, and a second FM layer. The second FM layer may comprise a single layer of Fe or FeSiAl, or a multilayer structure of Cr/Fe, NiAl/Fe, FeSiAl/Fe, or Fe/FeSiAl. The second FM layer may be amorphous. An optional synthetic anti-ferromagnetic (SAF) pinning layer is disposed on the second FM layer. The sensor comprising one or more FM layers comprising Fe reduces the coercivity and magnetostriction and improves the stability.

In one embodiment, a sensor comprises a seed layer, a first buffer layer disposed on the seed layer, a first ferromagnetic (FM) layer disposed on the first buffer layer, the first buffer and FM layer comprising a single layer of Fe or FeSiAl, or a multilayer structure of Cr/Fe, NiAl/Fe, IrAl/Fe, FeSiAl/Fe, or Fe/FeSiAl, a first Co comprising layer disposed on the FM layer, the first Co comprising layer comprising Co or CoFe, and a barrier layer disposed on the first Co comprising layer.

In another embodiment, a sensor comprises a seed layer, a first buffer layer disposed on the seed layer, the first buffer layer comprising NiAl, IrAl, or Cr, a first ferromagnetic (FM) layer disposed on the first buffer layer, the first FM layer comprising a single layer of Fe or FeSiAl, or a multilayer structure of Fe, FeSiAl/Fe, or Fe/FeSiAl, a first Co comprising layer disposed on the FM layer, the first Co comprising layer comprising Co or CoFe, a barrier layer disposed on the first Co comprising layer, a second Co comprising layer disposed on the barrier layer, the second Co comprising layer comprising Co or CoFe, wherein the first and second Co comprising layers each has a thickness of about 3 Å to about 8 Å, and a second FM layer disposed on the second Co comprising layer.

In yet another embodiment, a sensor comprises a seed layer, a first buffer layer disposed on the seed layer, the first buffer layer comprising NiAl, IrAl, or Cr, a first ferromagnetic (FM) layer disposed on the first buffer layer, the first FM layer comprising a single layer of Fe or FeSiAl, or a multilayer structure ofFeSiAl/Fe, or Fe/FeSiAl, a first Co comprising layer disposed on the FM layer, the first Co comprising layer comprising Co or CoFe, a MgO layer disposed on the first Co comprising layer, a second Co comprising layer disposed on the MgO layer, the second Co comprising layer comprising Co or CoFe, wherein the first and second Co comprising layers each has a thickness of about 3 Å to about 8 Å, a second FM layer disposed on the second Co comprising layer, the second FM layer comprising a single layer of Fe or FeSiAl, or a multilayer structure of Fe/Cr, Fe/NiAl, Fe/IrAl, FeSiAl/Fe, or Fe/FeSiAl, and a cap layer disposed on the second FM layer.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of certain embodiments of a magnetic media drive including a magnetic recording head with a spintronic device.

FIG. 2 is a fragmented, cross-sectional view of certain embodiments of a read/write head with a spintronic device.

FIG. 3 illustrates a single free layer structure of a read sensor comprising one ferromagnetic (FM) layer, according to one embodiment.

FIG. 4 illustrates a read sensor comprising two FM layers, according to one embodiment.

FIG. 5A illustrates a read sensor comprising two FM layers, according to another embodiment.

FIG. 5B illustrates the SAF pinning layer of FIG. 5A, according to one embodiment.

FIG. 6 illustrates a read sensor comprising two FM layers, according to yet another embodiment.

FIG. 7 illustrates a graph showing magnetoresistance (MR) versus resistance area (RA) for the sensor of FIG. 5A, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to magnetic recording devices comprising a sensor. A sensor comprises a first buffer layer, a first ferromagnetic (FM) layer, the first FM layer comprising a single layer of Fe or FeSiAl, or a multilayer structure of Cr/Fe, NiAl/Fe, IrAl/Fe, FeSiAl/Fe, or Fe/FeSiAl, a first Co or CoFe layer, and a barrier layer. The sensor may further comprise a second Co or CoFe layer, a second interface layer, and a second FM layer. The second FM layer may comprise a single layer of Fe or FeSiAl, or a multilayer structure of Fe/Cr, Fe/NiAl, Fe/IrAl, FeSiAl/Fe, or Fe/FeSiAl. The second FM layer may be amorphous and comprise CoB, CoFeB, or CoFeTaB. A synthetic anti-ferromagnetic (SAF) pinning layer disposed on the second FM layer. The sensor comprising one or more FM layers comprising Fe reduces the coercivity and magnetostriction and improves the stability.

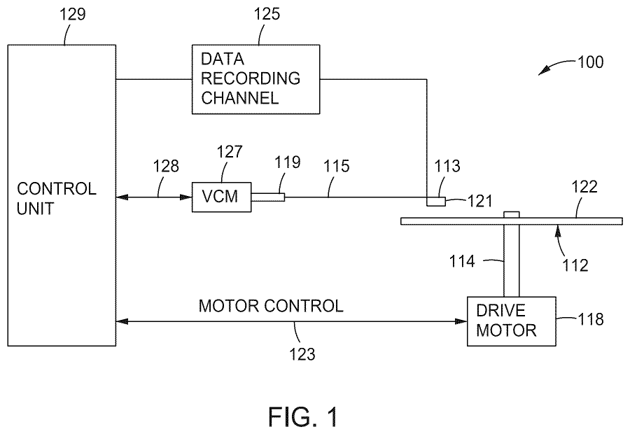

FIG. 1 is a schematic illustration of certain embodiments of a magnetic media drive 100 including a magnetic recording head with a SOT, tunnel magnetoresistive (TMR), or magnetic tunnel junction (MTJ) device. Such a magnetic media drive may be a single drive or comprise multiple drives. For illustration, a single disk drive 100 is shown according to certain embodiments. As shown, at least one rotatable magnetic disk 112 is supported on a spindle 114 and rotated by a drive motor 118. The magnetic recording on each magnetic disk 112 is in the form of any suitable patterns of data tracks, such as annular patterns of concentric data tracks (not shown) on the magnetic disk 112.

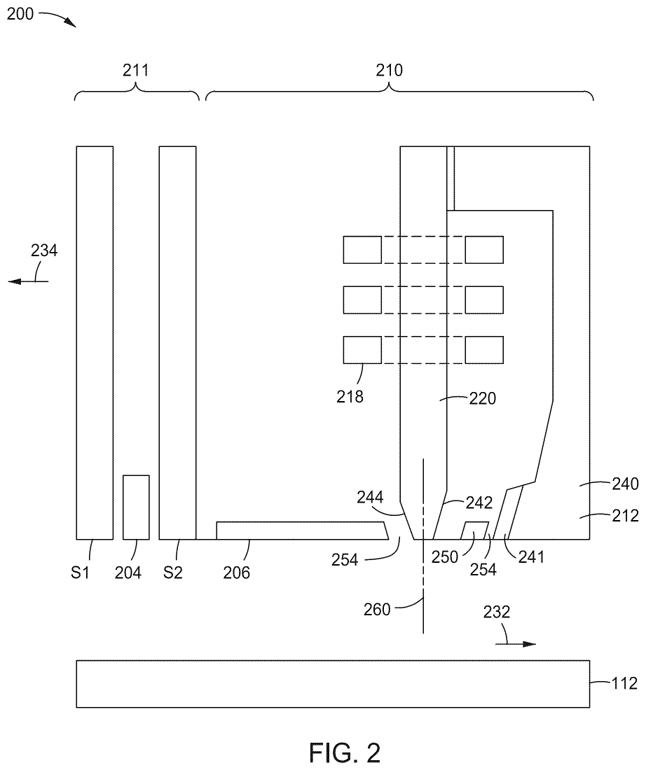

At least one slider 113 is positioned near the magnetic disk 112, and each slider 113 supports one or more magnetic head assemblies 121, including a SOT device. As the magnetic disk 112 rotates, the slider 113 moves radially in and out over the disk surface 122 so that the magnetic head assembly 121 may access different tracks of the magnetic disk 112 where desired data are written. Each slider 113 is attached to an actuator arm 119 by a suspension 115. The suspension 115 provides a slight spring force which biases the slider 113 toward the disk surface 122. Each actuator arm 119 is attached to an actuator means 127. The actuator means 127, as shown in FIG. 2, may be a voice coil motor (VCM). The VCM includes a coil movable within a fixed magnetic field, the direction and speed of the coil movements being controlled by the motor current signals supplied by the control unit 129.

During operation of the disk drive 100, the rotation of the magnetic disk 112 generates an air bearing between the slider 113 and the disk surface 122 which exerts an upward force or lift on the slider 113. The air bearing thus counterbalances the slight spring force of suspension 115, and supports slider 113 off and slightly above the disk surface 122 by a small, substantially constant spacing during regular operation.

The various components of the disk drive 100 are operated by control signals generated by control unit 129, such as access control signals and internal clock signals. The control unit 129 typically comprises logic control circuits, storage means, and a microprocessor. The control unit 129 generates control signals to control various system operations such as drive motor control signals on line 123 and head position and seek control signals on line 128. The control signals on line 128 provide the desired current profiles to move optimally and position slider 113 to the desired data track on disk 112. Write and read signals are communicated to and from write and read heads on the assembly 121 by recording channel 125.

The above description of a typical magnetic media drive and the accompanying illustration of FIG. 1 are for representation purposes only. It should be apparent that magnetic media drives may contain a large number of media, or disks, and actuators, and each actuator may support a number of sliders.

It is to be understood that the embodiments discussed herein are applicable to a data storage device such as a hard disk drive (HDD) as well as a tape drive such as a tape embedded drive (TED) or an insertable tape media drive. An example TED is described in co-pending patent application titled “Tape Embedded Drive,” U.S. application Ser. No. 16/365,034, filed Mar. 31, 2019, assigned to the same assignee of this application, which is herein incorporated by reference. As such, any reference in the detailed description to an HDD or tape drive is merely for exemplification purposes and is not intended to limit the disclosure unless explicitly claimed. For example, references to disk media in an HDD embodiment are provided as examples only, and can be substituted with tape media in a tape drive embodiment. Furthermore, reference to or claims directed to magnetic recording devices or data storage devices are intended to include at least both HDD and tape drive unless HDD or tape drive devices are explicitly claimed. In addition, the various embodiments disclosed herein may be used as part of magnetic field sensors generally, outside of the magnetic sensing application in data storage devices.

FIG. 2 is a fragmented, cross-sectional side view of certain embodiments of a read/write head 200 having a SOT, TMR, or MTJ device. The read/write head 200 faces a magnetic media 112. The read/write head 200 may correspond to the magnetic head assembly 121 described in FIG. 1. The read/write head 200 includes a media facing surface (MFS) 212, such as a gas bearing surface, facing the disk 112, a write head 210, and a magnetic read head 211. As shown in FIG. 2, the magnetic media 112 moves past the write head 210 in the direction indicated by the arrow 232, and the read/write head 200 moves in the direction indicated by the arrow 234.

In some embodiments, the magnetic read head 211 is a magnetoresistive (MR) read head with an MR sensing element 204 located between MR shields S1 and S2. In other embodiments, the magnetic read head 211 is a magnetic tunnel junction (MTJ) read head that includes an MTJ sensing device 204 disposed between MR shields S1 and S2. The magnetic fields of the adjacent magnetized regions in the magnetic disk 112 are detectable by the MR (or MTJ) sensing element 204 as the recorded bits.

The write head 210 includes a central or main pole 220, a leading shield 206, a trailing shield 240, an optional assistive write element 250, and a coil 218 that excites the main pole 220. The coil 218 may have a “pancake” structure that winds around a back-contact between the main pole 220 and the trailing shield 240, instead of a “helical” structure shown in FIG. 2. For example, when included, e.g., to achieve a Microwave Assisted Magnetic Recording (MAMR) effect, the assistive write element 250 is formed in a gap 254 between the main pole 220 and the trailing shield 240. The assistive write element 250 may be a spin torque oscillator (STO) device or a conductive stack, for example. In certain embodiments, the read/write head 200 additionally includes mechanisms (not shown) for supporting Heat Assisted Magnetic Recording (HAMR), which may include a waveguide coupled to a light source and a near field transducer (NFT) placed adjacent to the main pole 220 and coupled to the waveguide to convert the delivered light into a heating spot on the media.

The main pole 220 includes a trailing taper 242 and a leading taper 244. The trailing taper 242 extends from a location recessed from the MFS 212 to the MFS 212. The leading taper 244 extends from a location recessed from the MFS 212 to the MFS 212. The trailing taper 242 and the leading taper 244 may have the same degree of taper, and the degree of taper is measured with respect to a longitudinal axis 260 of the main pole 220. In some embodiments, the main pole 220 does not include the trailing taper 242 and the leading taper 244. Instead, the main pole 220 includes a trailing side (not shown) and a leading side (not shown), and the trailing side and the leading side are substantially parallel. The main pole 220 may be a magnetic material, such as a FeCo alloy. The leading shield 206 and the trailing shield 240 may comprise magnetic materials, such as a NiFe alloy.

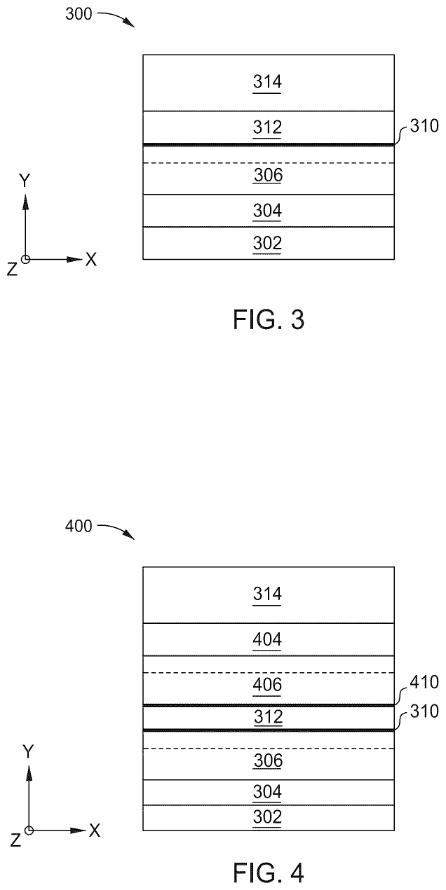

FIGS. 3-6 illustrate various read sensors 300, 400, 500, 600, respectively, according to various embodiments. Each read sensor 300, 400, 500, 600 may individually correspond to, or be a part of, the magnetic head assembly 121 described in FIG. 1. Each read sensor 300, 400, 500, 600 may individually correspond to, or be a part of, the read/write head 200 described in FIG. 2, such as the magnetic read head 211. Aspects of the read sensors 300, 400, 500, 600 may be used in combination with one another.

FIG. 3 illustrates a free layer structure 300 of a read sensor comprising one ferromagnetic (FM) layer 306, according to one embodiment. The read sensor 300 comprises a seed layer 302, a buffer layer 304 disposed on the seed layer 302, a FM layer 306 disposed on the buffer layer 304, a Co comprising interlayer 310 disposed on the FM layer 306, a barrier layer 312 disposed on the Co comprising interlayer 310, and a cap layer 314 disposed on the barrier layer 312.

The seed layer 302 comprises RuAl and has a thickness in the y-direction of about 25 Å to about 35 Å, such as about 30 Å. The buffer layer 304 comprises NiAl, IrAl, or Cr, and has a thickness in the y-direction of about 5 Å to about 10 Å. The buffer layer 304 helps improve magnetic properties of the sensor and helps to reduce the coercivity of the sensor 300. The barrier layer 312 comprises MgO and has a thickness in the y-direction of about 5 Å to about 10 Å. The cap layer 314 comprises RuAl, Ru, or a combination thereof in a multilayer, and has a thickness in the y-direction of about 60 Å.

The Co comprising interlayer 310 comprises Co or CoFe, and has a thickness in the y-direction of about 3 Å to about 8 Å, such as about 5 Å. The Co comprising interlayer 310 prevents perpendicular anisotropy from being introduced between the FM layer 306 and the barrier layer 312, and improves the interface spin polarization. The FM layer 306 comprises a single layer or a multilayer structure of Fe, FeSiAl, Fe/FeSiAl, or a combination thereof.

For example, the buffer layer 304 with the FM layer 306 comprises Cr/Fe, NiAl/Fe, IrAl/Fe, Cr/FeSiAl, NiAl/FeSiAl, IrAl/FeSiAl, Cr/FeSiAl/Fe, NiAl/FeSiAl/Fe, IrAl/FeSiAl/Fe, Cr/Fe/FeSiAl, NiAl/Fe/FeSiAl, or IrAl/Fe/FeSiAl, where “/” denotes separate sublayers of a multilayer structure. The dashed line represents the FM layer 306 optionally being a multilayer structure. The FM layer 306 has a total thickness in the y-direction of about 40 Å to about 60 Å, such as about 50 Å. When the FM layer 306 is a multilayer structure, such as FeSiAl/Fe, the Fe sublayer has a thickness in the y-direction of about 10 Å to about 20 Å. The FM layer 306 comprising Fe, either as a single layer or in a multilayer structure, reduces the coercivity and magnetostriction (Ms) while improving the magnetoresistance (MR) and stability of the sensor. For example, the coercivity is between about 3 Oe to about 6 Oe, and the Ms is between about 1 ppm to about 2.6 ppm. The Fe comprising FM layer 306 further helps reduce any defects introduced to the barrier layer 312.

A low resistance area (RA) with minimal defects in the barrier layer 312 (e.g., MgO) is helpful for ensuring the reliability of high areal density capable read sensors. Previously, a structure employing CoFe (as the FM layer) with a RuAl seed layer was developed to offer a textured template for larger grain size and boron-free barrier layer (e.g., MgO) growth. However, the magnetostriction and saturation magnetization of the CoFe-based free layer exceeded that of an amorphous CoB structure preferred in some applications, potentially impacting the signal-to-noise ratio (SNR) and stability of the read sensor. While an Fe comprising FM layer would result in reduced magnetostriction, it could introduce high coercivity and shallow saturation transition, as well as possible degradation of magneto-resistance as compared to a Co-based FM layer. Hence, the buffer layer 304 helps recover the low Hc of the FM layer, and, as noted above, the Co comprising interlayer 310 prevents perpendicular anisotropy from being introduced between the FM layer 306 and the barrier layer 312, and improves the interface spin polarization. The combination of these layers address these noted issues and provide improved overall sensor performance.

FIG. 4 illustrates a read sensor 400 comprising two FM layers 306, 406, according to one embodiment. The read sensor 400 comprises the seed layer 302, a first buffer layer 304 disposed on the seed layer 302, a first FM layer 306 disposed on the first buffer layer 304, a first Co or CoFe comprising interlayer 310 disposed on the first FM layer 306, a barrier layer 312 disposed on the first Co comprising interlayer 310, a second Co or CoFe comprising interlayer 410 disposed on the barrier layer 312, a second FM layer 406 disposed on the second Co or CoFe comprising interlayer 410, a second buffer layer 404 disposed on the second FM layer 406, and the cap layer 314 disposed on the second buffer layer 404. The second Co comprising interlayer 410 improves the texture of the second FM layer 406 and improves the interface spin polarization.

The second Co comprising interlayer 410 comprises Co or CoFe, and has a thickness in the y-direction of about 3 Å to about 8 Å, such as about 5 Å. The second buffer layer 404 comprises the same materials and has the same thickness ranges as the first buffer layer 304. The second FM layer 406 comprises Fe/Cr, Fe/NiAl, Fe/IrAl, FeSiAl, FeSiAl/Fe, or Fe/FeSiAl and has the same thickness ranges as the first FM layer 306. As such, the second FM layer 406 comprising Fe, either as a single layer or in a multilayer structure, further reduces the coercivity and Ms while improving the stability of the sensor.

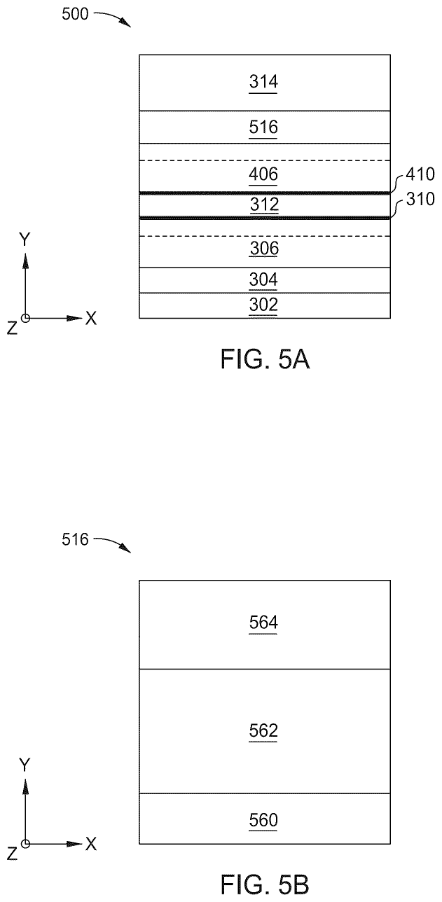

FIG. 5A illustrates a read sensor 500 comprising two FM layers 306, 406, according to another embodiment. The read sensor 500 is similar to the read sensor 400 of FIG. 4; however, the read sensor 500 comprises a synthetic anti-ferromagnetic (SAF) pinning and anti-ferromagnetic (AFM) layer 516 instead of a second buffer layer 404. The read sensor 500 comprises the seed layer 302, the buffer layer 304 disposed on the seed layer 302, a first FM layer 306 disposed on the buffer layer 304, a first Co comprising interlayer 310 disposed on the first FM layer 306, a barrier layer 312 disposed on the first Co comprising interlayer 310, a second Co comprising interlayer 410 disposed on the barrier layer 312, a second FM layer 406 disposed on the second Co comprising interlayer 410, the SAF pinning layer 516 disposed on the second FM layer 406, and the cap layer 314 disposed on the SAF pinning layer 516. The SAF pinning layer 516 comprises Ru or RuAl spacer layer, a ferromagnetic layer, and an AFM layer, such as IrMn, like shown in FIG. 5B.

FIG. 5B illustrates the SAF pinning layer 516, according to one embodiment. The SAF pinning layer 516 comprises a spacer layer 560, an FM layer structure 562 disposed on the spacer layer 560, and an AFM layer 564 disposed on the FM layer structure 562. The spacer layer 560 is disposed on the second FM layer 406, and the cap layer 314 is disposed on the AFM layer 564. The spacer layer 560 comprises Ru or RuAl and has a thickness of about 4 Å to about 15 Å. The FM layer structure 562 comprises Co, CoFe, CoFeBTa, or combination thereof, and has a thickness of about 50 Å. The AFM layer 564 comprises IrMn and has a thickness of about 40 Å to about 60 Å.

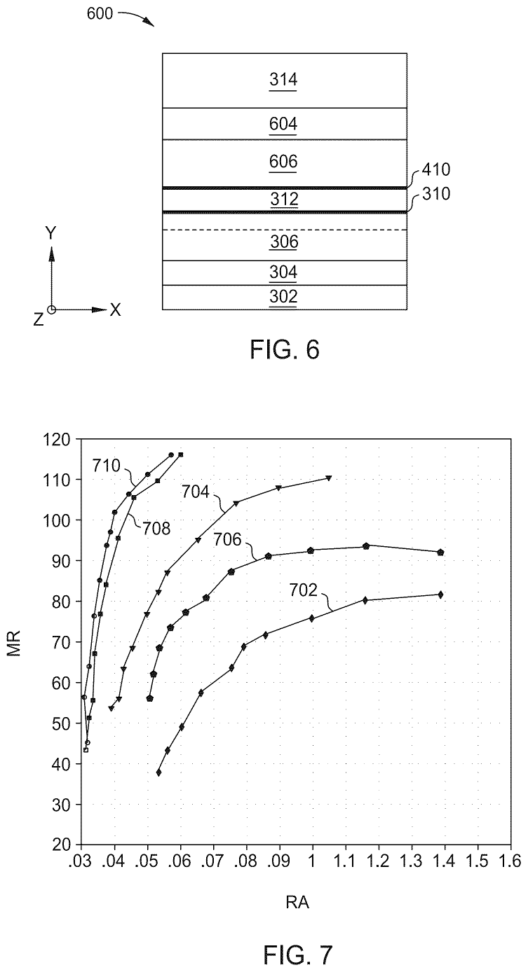

FIG. 6 illustrates a read sensor 600 comprising two FM layers 306, 406, according to yet another embodiment. The read sensor 600 is similar to the read sensor 400 of FIG. 4; however, the second FM layer 604 is amorphous. The read sensor 500 comprises the seed layer 302, the first buffer layer 304 disposed on the seed layer 302, a first FM layer 306 disposed on the first buffer layer 304, a first Co or CoFe comprising interlayer 310 disposed on the first FM layer 306, a barrier layer 312 disposed on the first Co comprising interlayer 310, a second Co or CoFe comprising interlayer 410 disposed on the barrier layer 312, the amorphous FM layer 606 disposed on the second Co or CoFe comprising interlayer 410, a second buffer layer 604 disposed on the amorphous FM layer 606, and the cap layer 314 disposed on the second buffer layer 604. The amorphous FM layer 606 comprises CoB, CoFeB, CoHf, CoFeBTa, or a combination thereof as a multilayer, and has a thickness in the y-direction of about 50 Å. The second buffer layer 606 may comprise CoHf.

FIG. 7 illustrates a graph 700 showing magnetoresistance (MR) versus resistance area (RA) for the sensor 500 of FIG. 5A, according to one embodiment. While the graph 700 is based off the sensor 500, the graph 700 similarly applies to the sensors 300, 400, and 600 of FIGS. 3, 4, and 6.

Line 702 represents the FM layer 306 comprising FeAlSi; line 704 represents the FM layer 306 comprising FeAlSi/Fe, where the FeAlSi sublayer has a thickness of about 40 A and the Fe sublayer has a thickness of about 10 Å; line 706 represents the FM layer 306 comprising Fe/FeAlSi, where the FeAlSi sublayer has a thickness of about 30 A and the Fe sublayer has a thickness of about 20 Å; line 708 represents the FM layer 306 comprising FeAlSi/Fe, where the FeAlSi sublayer has a thickness of about 30 Å and the Fe sublayer has a thickness of about 20 Å; and line 710 represents the FM layer 306 comprising FeAlSi/Fe with reduced barrier thickness, where the FeAlSi sublayer has a thickness of about 30 Å and the Fe sublayer has a thickness of about 20 Å. As shown by the graph 700, each FM layer comprising Fe increases the MR and the areal density capacity (ACD) while reducing the RA, thus improving the sensor.

Therefore, a read sensor comprising one or more FM layers comprising Fe, either as a single layer or in a multilayer structure, the coercivity and Ms are reduced while the stability and MR of the sensor is improved. The Fe comprising FM layer(s) further help reduce any defects introduced by the barrier layer. As such, the read sensor has an improved stability and a low resistance area (RA) without impacting the SNR.

In one embodiment, a sensor comprises a seed layer, a first buffer layer disposed on the seed layer, a first ferromagnetic (FM) layer disposed on the first buffer layer, the first FM layer comprising a single layer of Fe or FeSiAl, or a multilayer structure of Cr/Fe, NiAl/Fe, IrAl/Fe, FeSiAl/Fe, or Fe/FeSiAl, a first Co comprising layer disposed on the first FM layer, the first Co comprising layer comprising Co or CoFe, and a barrier layer disposed on the first Co comprising layer.

The sensor further comprises a cap layer disposed on the barrier layer. The sensor further comprises a second Co comprising layer disposed on the barrier layer, the second Co comprising layer comprising Co or CoFe, and a second FM layer disposed on the second Co comprising layer comprising Co or CoFe. The sensor further comprises a second buffer layer disposed on the second FM layer, and a cap layer disposed on the second buffer layer, wherein the second FM layer comprises a single layer of Fe or FeSiAl, or a multilayer structure of Cr/Fe, NiAl/Fe, FeSiAl/Fe, or Fe/FeSiAl. The second FM layer comprises an amorphous material. The sensor further comprises a synthetic anti-ferromagnetic (SAF) pinning and anti-ferromagnetic (AFM) layer disposed on the second FM layer, and a cap layer disposed on the SAF pinning and AFM layer. The first FM layer comprises the single layer of FeSiAl. The first FM layer comprises the multilayer structure of Cr/Fe, NiAl/Fe, FeSiAl/Fe, or Fe/FeSiAl. A magnetic recording device comprises the sensor.

In another embodiment, a sensor comprises a seed layer, a first buffer layer disposed on the seed layer, the first buffer layer comprising NiAl or Cr, a first ferromagnetic (FM) layer disposed on the first buffer layer, the first FM layer comprising a single layer of Fe or FeSiAl, or a multilayer structure of Cr/Fe, NiAl/Fe, FeSiAl/Fe, or Fe/FeSiAl, a first Co comprising layer disposed on the first FM layer, the first Co comprising layer comprising Co or CoFe, a barrier layer disposed on the first Co comprising layer, a second Co comprising layer disposed on the barrier layer, the second Co comprising layer comprising Co or CoFe, wherein the first and second Co comprising layers each has a thickness of about 3 Å to about 8 Å, and a second FM layer disposed on the second Co comprising layer.

The second FM layer comprises a single layer of Fe or FeSiAl, or a multilayer structure of Fe/Cr, Fe/NiAl, Fe/IrAl, FeSiAl/Fe, or Fe/FeSiAl. The second FM layer is an amorphous FM layer comprising CoB, CoHf, CoFeB, CoFeBTa, or a combination thereof. The sensor further comprises a synthetic anti-ferromagnetic (SAF) pinning and anti-ferromagnetic (AFM) layer disposed on the second FM layer. The first FM layer has a thickness of about 40 Å to about 50 Å. The sensor further comprises a second buffer layer disposed on the second FM layer, the second buffer layer comprising NiAl, IrAl, or Cr. The second FM layer comprises the multilayer structure of Cr/Fe, NiAl/Fe, FeSiAl/Fe, or Fe/FeSiAl. The first FM layer comprises the single layer of FeSiAl. The first FM layer comprises the multilayer structure of Cr/Fe, NiAl/Fe, FeSiAl/Fe, or Fe/FeSiAl. A magnetic recording device comprises the sensor.

In yet another embodiment, a sensor comprises a seed layer, a first buffer layer disposed on the seed layer, the first buffer layer comprising NiAl or Cr, a first ferromagnetic (FM) layer disposed on the first buffer layer, the first FM layer comprising a single layer of Fe or FeSiAl, or a multilayer structure of Cr/Fe, NiAl/Fe, FeSiAl/Fe, or Fe/FeSiAl, a first Co comprising layer disposed on the first FM layer, the first Co comprising layer comprising Co or CoFe, a MgO layer disposed on the first Co comprising layer, a second Co comprising layer disposed on the MgO layer, the second Co comprising layer comprising Co or CoFe, wherein the first and second Co comprising layers each has a thickness of about 3 Å to about 8 Å, a second FM layer disposed on the second Co comprising layer, the second FM layer comprising a single layer of Fe or FeSiAl, or a multilayer structure of Cr/Fe, NiAl/Fe, IrAl/Fe, FeSiAl/Fe, or Fe/FeSiAl, and a cap layer disposed on the second FM layer.

The sensor further comprises a second buffer layer disposed between the second FM layer and the cap layer, the second buffer layer comprising NiAl, IrAl, or Cr. The sensor further comprises a synthetic anti-ferromagnetic (SAF) pinning and anti-ferromagnetic (AFM) layer disposed on the second FM layer. The seed layer comprises RuAl. The first and second FM layers each individually has a thickness of about 40 Å to about 50 Å. The first and second FM layers each individually comprises the single layer of FeSiAl. The first and second FM layers each individually comprises the multilayer structure of Cr/Fe, NiAl/Fe, FeSiAl/Fe, or Fe/FeSiAl. A magnetic recording device comprises the read sensor.

While the foregoing is directed to embodiments of the present disclosure, other and further embodiments of the disclosure may be devised without departing from the basic scope thereof, and the scope thereof is determined by the claims that follow.

1. A sensor, comprising:
a seed layer;
a first buffer layer disposed on the seed layer;
a first ferromagnetic (FM) layer disposed on the first buffer layer, the first FM layer comprising a single layer of Fe or FeSiAl, or a multilayer structure of Cr/Fe, NiAl/Fe, FeSiAl/Fe, or Fe/FeSiAl;
a first Co comprising layer disposed on the first FM layer, the first Co comprising layer comprising Co or CoFe; and
a barrier layer disposed on the first Co comprising layer.

2. The sensor of claim 1, further comprising a cap layer disposed on the barrier layer.

3. The sensor of claim 1, further comprising:
a second Co comprising layer disposed on the barrier layer, the second Co comprising layer comprising Co or CoFe; and
a second FM layer disposed on the second Co comprising layer.

4. The sensor of claim 3, further comprising:
a second buffer layer disposed on the second FM layer; and
a cap layer disposed on the second buffer layer, wherein the second FM layer comprises a single layer of Fe or FeSiAl, or a multilayer structure of Cr/Fe, NiAl/Fe, IrAl/Fe, FeSiAl/Fe, or Fe/FeSiAl.

5. The sensor of claim 3, wherein the second FM layer comprises an amorphous material.

6. The sensor of claim 3, further comprising:
a synthetic anti-ferromagnetic (SAF) pinning and anti-ferromagnetic (AFM) layer disposed on the second FM layer; and
a cap layer disposed on the SAF pinning and AFM layer.

7. The sensor of claim 1, wherein the first FM layer comprises the single layer of FeSiAl.

8. The sensor of claim 1, wherein the first FM layer comprises the multilayer structure of Cr/Fe, NiAl/Fe, FeSiAl/Fe, or Fe/FeSiAl.

9. A magnetic recording device comprising the sensor of claim 1.

10. A sensor, comprising:
a seed layer;
a first buffer layer disposed on the seed layer, the first buffer layer comprising NiAl, IrAl, or Cr;
a first ferromagnetic (FM) layer disposed on the first buffer layer, the first FM layer comprising a single layer of Fe FeSiAl, or a multilayer structure of FeSiAl/Fe, or Fe/FeSiAl;
a first Co comprising layer disposed on the first FM layer, the first Co comprising layer comprising Co or CoFe;
a barrier layer disposed on the first Co comprising layer;
a second Co comprising layer disposed on the barrier layer, the second Co comprising layer comprising Co or CoFe, wherein the first and second Co comprising layers each has a thickness of about 3 Å to about 8 Å; and
a second FM layer disposed on the second Co comprising layer.

11. The sensor of claim 10, wherein the second FM layer comprises a single layer of Fe FeSiAl, or a multilayer structure of Fe/Cr, Fe/NiAl, Fe/IrAl, FeSiAl/Fe, or Fe/FeSiAl.

12. The sensor of claim 10, wherein the second FM layer is an amorphous FM layer comprising CoB, CoHf, CoFeB, CoFeBTa, or a combination thereof.

13. The sensor of claim 10, further comprising a synthetic anti-ferromagnetic (SAF) pinning and anti-ferromagnetic (AFM) layer disposed on the second FM layer.

14. The sensor of claim 10, wherein the first FM layer has a thickness of about 40 Å to about 50 Å.

15. The sensor of claim 10, further comprising a second buffer layer disposed on the second FM layer, the second buffer layer comprising NiAl, IrAl, or Cr.

16. The sensor of claim 10, wherein the second FM layer comprises the multilayer structure of Cr/Fe, NiAl/Fe, FeSiAl/Fe, or Fe/FeSiAl.

17. The sensor of claim 10, wherein the first FM layer comprises the single layer of FeSiAl.

18. The sensor of claim 10, wherein the first FM layer comprises the multilayer structure of Cr/Fe, NiAl/Fe, FeSiAl/Fe, or Fe/FeSiAl.

19. A magnetic recording device comprising the sensor of claim 10.

20. A sensor, comprising:
a seed layer;
a first buffer layer disposed on the seed layer, the first buffer layer comprising NiAl, IrAl, or Cr;
a first ferromagnetic (FM) layer disposed on the first buffer layer, the first FM layer comprising a single layer of Fe or FeSiAl, or a multilayer structure of Cr/Fe, NiAl/Fe, FeSiAl/Fe, or Fe/FeSiAl;
a first Co comprising layer disposed on the first FM layer, the first Co comprising layer comprising Co or CoFe;
a MgO layer disposed on the first Co comprising layer;
a second Co comprising layer disposed on the MgO layer, the second Co comprising layer comprising Co or CoFe, wherein the first and second Co comprising layers each has a thickness of about 3 Å to about 8 Å;
a second FM layer disposed on the second Co comprising layer, the second FM layer comprising a single layer of Fe or FeSiAl, or a multilayer structure of Cr/Fe, NiAl/Fe, IrAl/Fe, FeSiAl/Fe, or Fe/FeSiAl; and
a cap layer disposed on the second FM layer.

21. The sensor of claim 20, further comprising a second buffer layer disposed between the second FM layer and the cap layer, the second buffer layer comprising NiAl, IrAl, or Cr.

22. The sensor of claim 20, further comprising a synthetic anti-ferromagnetic (SAF) pinning and anti-ferromagnetic (AFM) layer disposed on the second FM layer.

23. The sensor of claim 20, wherein the seed layer comprises RuAl.

24. The sensor of claim 20, wherein the first and second FM layers each individually has a thickness of about 40 Å to about 50 Å.

25. The sensor of claim 20, wherein the first and second FM layers each individually comprises the single layer of FeSiAl.

26. The sensor of claim 20, wherein the first and second FM layers each individually comprises the multilayer structure of Cr/Fe, NiAl/Fe, FeSiAl/Fe, or Fe/FeSiAl.

27. A magnetic recording device comprising the sensor of claim 20.
